(19) United States
(12) Patent Application Publication
(10) Pub. No.: US 2025/0047791 A1
(43) Pub. Date: Feb. 6, 2025

(54) IMAGE INSPECTION APPARATUS, IMAGE INSPECTION METHOD, NON-TRANSITORY RECORDING MEDIUM, AND IMAGE FORMING SYSTEM

(71) Applicant: KONICA MINOLTA, INC., Tokyo (JP)

(72) Inventor: Yasumasa TSUKAMOTO, Tokyo (JP)

(73) Assignee: KONICA MINOLTA, INC., Tokyo (JP)

(21) Appl. No.: 18/753,340

(22) Filed: Jun. 25, 2024

(30) Foreign Application Priority Data
Aug. 3, 2023 (JP) 2023-126849

(51) Int. Cl. H04N 1/00; G06T 7/00

(52) U.S. Cl. CPC H04N 1/00045; G06T 7/001; H04N 1/00015; G06T 2207/30144

(57) ABSTRACT

An image inspection apparatus includes a hardware processor, and the hardware processor inspects an image formed on each of recording media of a plurality of copies based on acquired image data. The hardware processor generates, for each of the copies, a reference image to be used for inspection of an image formed on each of the recording media of the plurality of copies.

### CROSS-REFERENCE TO RELATED APPLICATION

Japanese patent application No. 2023-126849 filed on Aug. 3, 2023, including description, claims, drawings, and abstract the entire disclosure is incorporated herein by reference in its entirety.

### BACKGROUND OF THE INVENTION

### 1. Technical Field

The present invention relates to an image inspection apparatus, an image inspection method, a non-transitory recording medium, and an image forming system.

### 2. Description of Related Art

Conventionally, the quality of a printed product is inspected by comparing a reference image registered in advance with a read image obtained by reading the printed product to be inspected. The reference image can be, for example, an image having no abnormality in quality among images obtained by reading the printed product. Whether or not an abnormality in the quality is present is determined, for example, by an inspecting person visually checking and determining whether or not an abnormality is present. As an image forming apparatus including an image inspector that inspects qualities of printed products, for example, an image forming apparatus described in Japanese Unexamined Patent Publication No. 2016-146514 is known.

However, as in the image forming apparatus described in Japanese Unexamined Patent Publication No. 2016-146514, it takes time and labor for an inspecting person to perform visual checking in order to obtain reference images for all pages of a printed product. On the other hand, Japanese Unexamined Patent Publication No. 2015-53561 discloses a printed product inspection apparatus which inspects the quality of a printed product by comparing a document image as a reference image with a read image.

### SUMMARY OF THE INVENTION

The printed product inspection apparatus described in Japanese Unexamined Patent Publication No. 2015-53561 can save time and labor for visual checking in creating the reference image by using the document image as the reference image. However, there is a problem that a large amount of storage area of a memory is consumed in a case where the number of pages of document images is large.

The present invention has been made in consideration of the above-described circumstances, and an object of the present invention is to provide an image inspection apparatus, an image inspection method, an image inspection program, and an image forming system capable of suppressing consumption of a large amount of storage area of a memory even in a case where the number of pages of document images is large.

To achieve at least one of the abovementioned objects, according to an aspect of the present invention, an image inspection apparatus reflecting one aspect of the present invention comprises the followings.

An image inspection apparatus including: a controller that inspects an image formed on each of recording media of a plurality of copies based on acquired image data, wherein the controller generates, for each of the copies, a reference image to be used for inspection of the image formed on each of the recording media of the plurality of copies.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic block diagram of a printing system according to an embodiment of the present invention;

FIG. 2 is a schematic block diagram illustrating a configuration of an image forming system illustrated in FIG. 1;

FIG. 3 is a block diagram for explaining the outline of a control operation of a controller and a print controller illustrated in FIG. 2;

FIG. 4 is a flowchart illustrating a processing procedure of an image inspection method by the image forming system illustrated in FIG. 1;

FIG. 5 is a subroutine flowchart illustrating details of the inspection of an inspection image in the flowchart illustrated in FIG. 4;

FIG. 6 is a schematic diagram illustrating, in a time-series manner, processing of acquisition of a document image, generation of a reference image, formation of an inspection image, and inspection of the inspection image;

FIG. 7 is a schematic view illustrating printing of a plurality of copies of a document image in time series; and

FIG. 8 is a schematic diagram illustrating, in a time-series manner, processing of acquisition of a document image, generation of a reference image, formation of an inspection image, and inspection of the inspection image when recovery printing is performed.

### DETAILED DESCRIPTION

Hereinafter, one or more embodiments of the present invention will be described with reference to the drawings. However, the scope of the invention is not limited to the disclosed embodiments. Note that in the description of the drawings, the same components are denoted by the same reference signs, and redundant descriptions are omitted. In addition, dimensional ratios in the drawings are exaggerated for convenience of description and may be different from actual ratios.

### <Configuration of Printing System>

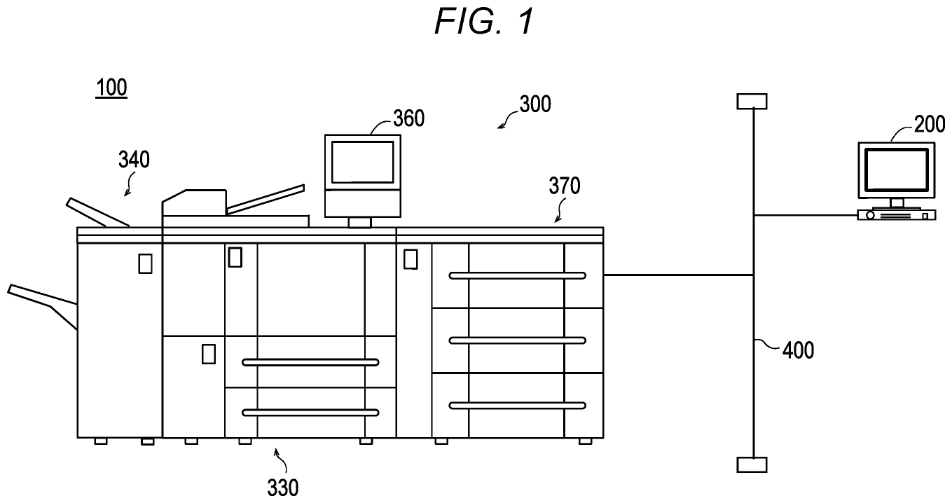

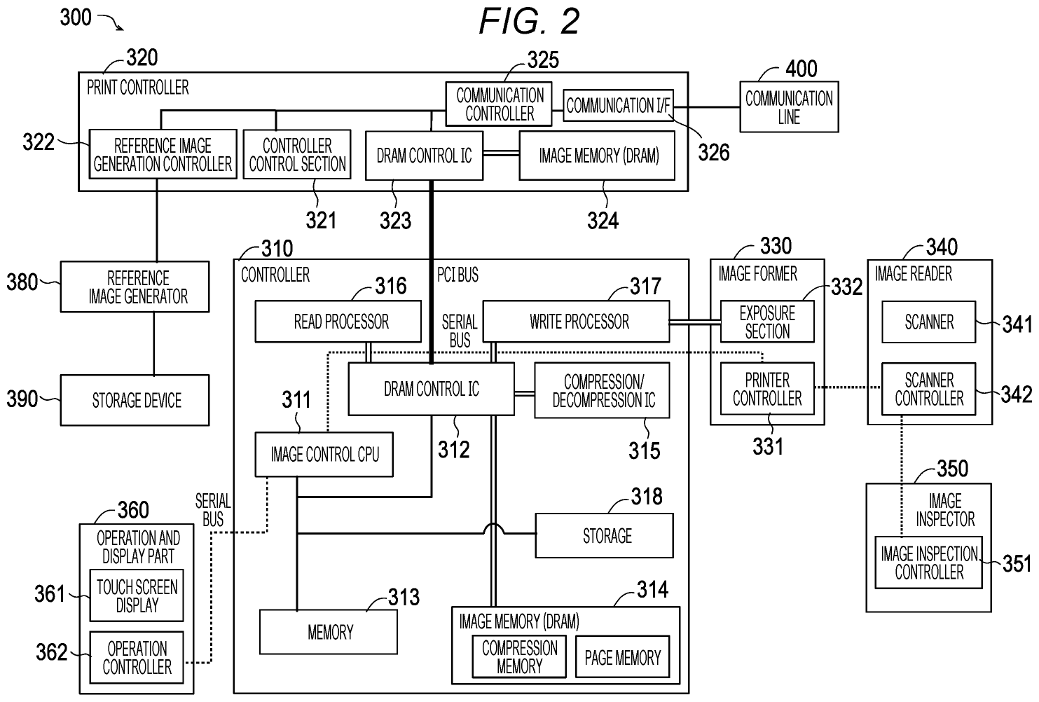

FIG. 1 is a schematic block diagram of a printing system according to a first embodiment of the present invention, and FIG. 2 is a schematic block diagram illustrating a configuration of an image forming system illustrated in FIG. 1.

As illustrated in FIG. 1, the printing system 100 includes a client terminal 200 and an image forming system 300. The client terminal 200 and the image forming system 300 are communicably connected to each other via a communication line 400.

The client terminal 200 may be, for example, a personal computer, a tablet terminal, a smartphone, or the like. A printer driver for converting document data into a print job is installed in the client terminal 200. The printer driver generates a print job in a format compatible with a print controller 320 (see FIG. 2) of the image forming system 300. The printer driver transmits the print job to the image forming system 300 through the communication line 400. In addition, the client terminal 200 includes a display, and can display a result (indicating a non-defective product or a defective product) of inspecting a printed product, an image of a defective printed product, and the like.

The print job includes, for example, print data in a page description language (PDL) format and job information. The print data includes, for example, print data of the first to m-th pages. The job information includes, for example, print settings such as the number of pages, the number of prints, the type of sheet (recording medium), the size, the basis weight, single-sided printing/double-sided printing, and inspection settings (inspection-on or inspection-off and an inspection level). A user can give an image inspection instruction to the image forming system 300 by setting the inspection setting to inspection-on.

The communication line 400 may include a local area network (LAN) in which a computer and a network device are connected to each other according to a predetermined standard, a wide area network (WAN) in which LANs are connected to each other by a dedicated line, or the like. The predetermined standard is, for example, Ethernet (R), Fiber Distributed Data Interface (FDDI), wireless fidelity (Wi-Fi), or the like.

Note that the number of the above constituent elements connected to the communication line 400 is not limited to that in the case illustrated in FIG. 1.

### <Configuration of Image Forming System 300>

As illustrated in FIGS. 1 and 2, the image forming system 300 includes a controller 310, a print controller 320, an image former 330, an image reader 340, an image inspector 350, an operation and display part 360, a sheet feeder 370, a reference image generator 380, and a storage device 390. The image forming system 300 functions as an image inspection apparatus.

### <Configuration of Controller 310>

The controller 310 includes an image control CPU 311, a dynamic random access memory (DRAM) control IC 312, a memory 313, an image memory (DRAM) 314, a compression/decompression IC 315, a read processor 316, a write processor 317, a storage 318, and the like.

The image control CPU (hardware processor) 311 develops various programs stored in the storage 318 in the memory 313, and comprehensively controls the operation of the entire image forming system 300 in cooperation with the developed programs.

The read processor 316 performs various kinds of processing such as analog processing, A/D conversion processing, and shading processing on an analog image signal output from a scanner 341 of the image reader 340, and generates digital image (read image) data. The generated digital image data is output to the compression/decompression IC 315 by the DRAM control IC 312. Under the control of the DRAM control IC 312, the compression/decompression IC 315 performs compression processing on digital image data and decompression processing on the digital image data after the compression processing. Furthermore, the DRAM control IC 312 controls input and output of the digital image data subjected to the compression and decompression processing to and from the image memory (DRAM) 314.

The image memory 314 is formed of a DRAM, includes regions of a compression memory and a page memory therein, and temporarily stores compressed image data, decompressed image data, and the like.

The write processor 317 outputs the decompressed digital image data to the exposure section 332 of the image former 330.

### <Configuration of Print Controller 320>

The print controller 320 analyzes the print job received from the client terminal 200 via the communication line 400. The print controller 320 performs processing such as color conversion, screening, and rasterization, and generates a document image in a bitmap format. The generated document image is transmitted to the controller 310. The print controller 320 functions as a document image acquirer.

The print controller 320 includes a controller control section 321, a reference image generation controller 322, a DRAM control IC 323, an image memory (DRAM) 324, a communication controller 325, and a communication I/F 326. The controller control section 321 comprehensively controls operation of each section of the print controller 320. Further, the controller control section 321 receives the print job from the client terminal 200 or the like via the communication I/F 326. The communication controller 325 controls the communication I/F 326.

The received print job includes print data (mainly in a PDL format) serving as a source of a document image and job information in which print settings such as the type of sheet to be used are described. The print controller 320 performs rasterization (RIP) processing for converting print data into bitmap data in units of pages based on the print settings. The RIP image after the rasterization processing is temporarily stored in the image memory 324. The RIP image in the image memory 324 is temporarily stored in a compression memory region in the image memory 314 via the compression/decompression IC 315 under the control of the DRAM control IC 323 of the print controller 320 and the DRAM control IC 312 of the controller 310. At the time of normal printing, the RIP image stored in the compression memory region is decompressed by the compression/decompression IC 315 and is transmitted to the image former 330 as a document image via the write processor 317, and printing is executed.

The reference image generation controller 322 outputs, at a predetermined generation timing, a reference image generation instruction to the reference image generator 380, which will be described later, such that the reference image generator 380 generates a reference image based on the document image. The predetermined generation timing can be, for example, a timing when the inspection setting is inspection-on and the document image acquirer acquires the document image. The reference image generator 380 generates the reference image based on the reference image generation instruction.

Ideally, a read image generated by reading an inspection image formed on a sheet is considered to match the document image in terms of content. However, when the inspection image formed on the sheet is read by the scanner, an error may occur in the read image with respect to the document image due to various factors such as a variation in a conveyance path of the sheet, misalignment of the reading position of the scanner, color reproducibility, and a difference in sheet type. An error may also occur in the document image depending on the resolution of reading by the scanner. Therefore, when the read image and the document image are simply compared, there is a high possibility that an error occurs, and it is not realistic to inspect the inspection image by simply comparing the read image with the document image. Therefore, in the present embodiment, the reference image generator 380 is configured to generate a reference image by performing various kinds of processing on the document image in terms of position, resolution, color, and the like so that the reference image can be compared with the read image. Thus, since the comparison with the read image is appropriately performed, the inspection of the printed product can be accurately performed. Details of the processing for generating the reference image will be described later. FIG. 2 illustrates the case where the reference image generation controller 322 is provided in the print controller 320, but the reference image generation controller 322 may be provided in the controller 310.

### <Configuration of Image Former 330>

The image former 330 forms (prints) an image on a sheet (recording medium) by an electrophotographic method including processing of charging, exposure, development, transfer, and fixing, in accordance with an instruction of the controller 310. In the present embodiment, the image former 330 forms an inspection image to be inspected by the image inspector 350 on a sheet under an image forming condition set based on the print settings. The image former 330 includes a printer controller 331 and the exposure section 332. The printer controller 331 is connected to the image control CPU 311 by serial communications, and accepts control by the image control CPU 311. The printer controller 331 drives a laser diode (LD) of the exposure section 332 according to a signal from the write processor 317, and forms an electrostatic latent image corresponding to a document image on a photoreceptor (not illustrated). The toner image formed on the photoreceptor is developed through development processing and is transferred onto a sheet supplied from the sheet feeder 370. Next, the unfixed toner image on the sheet is fixed by being heated and pressurized. The sheet on which the toner image has been fixed is conveyed to the image reader 340.

In addition, the image former 330 includes a print sheet ejection device that ejects (purges) a sheet (waste sheet) on which an inspection image in which an abnormality has been detected by the image inspector 350 has been formed separately from a sheet on which a normal inspection image has been formed.

### <Configuration of Image Reader 340>

The image reader 340 includes the scanner 341 and a scanner controller 342. For example, the scanner 341 reads a sheet (printed product) conveyed in the conveyance path by a charge coupled device (CCD) image sensor. The scanner controller 342 controls the scanner to read an inspection image formed on the sheet conveyed from the image former 330 according to a reading instruction from the controller 310. The scanner controller 342 outputs, to the controller 310, a read image obtained by reading the inspection image formed on the sheet.

### <Configuration of Image Inspector 350>

The image inspector 350 performs image inspection based on a reference image. More specifically, the image inspector 350 acquires the reference image and the read image, and compares the reference image with the read image for each page to inspect the inspection image formed on the sheet.

The image inspector 350 includes an image inspection controller 351. The image inspection controller 351 includes the image control CPU 311 or a CUP, a RAM, a ROM, and an auxiliary storage device (not illustrated). The function of inspecting an inspection image is implemented by the CPU executing an image inspection program. For example, the image inspection controller 351 calculates a difference (error) in pixel value between the reference image and the read image for each page, and determines the quality of the inspection image according to the magnitude of the difference. The calculation of the difference can be performed for each page, each object, or each region. For example, in a case where the difference is calculated for each page, an inspection result indicating “non-defective” is output when the total value of differences between pixels in one page is less than a specified value, and an inspection result indicating “defective” is output when the total value of the differences between the pixels in one page is equal to or more than the specified value. In addition, in a case of calculating differences for each object or for each region, an inspection result indicating “non-defective” or “defective” is output according to the total value of differences between pixel values in the selected object or region.

When the result of inspecting the inspection image indicates “non-defective”, the controller 310 determines that the printed product is a non-defective product. When the result of inspecting the inspection image indicates “defective”, the controller 310 determines that the printed product is a defective product.

### <Configuration of Operation and Display Part 360>

The operation and display part 360 includes a touch screen display 361, an operation controller 362, a numeric keypad as hardware keys, a start button, a stop button, and the like. The touch screen display includes, for example, a touch sensor and a liquid crystal display (LCD) disposed behind the touch sensor. The operation controller 362 receives input from the touch sensor and the hardware keys and transmits input data to the controller 310. Furthermore, the operation controller 362 receives output data from the controller 310 and causes the LCD to display the output data. The operation and display part 360 is used for user's input of various settings (e.g., inspection-on or inspection-off of the inspection setting, and the inspection level) and instructions (e.g., instruction to start printing). The operation and display part 360 is also used to output (display) the state of the image forming system 300, a result (non-defective product or defective product) of inspecting a printed product, an image of a defective printed product, and the like.

### <Configuration of Sheet Feeder 370>

The sheet feeder 370 includes at least one large-capacity sheet tray, and supplies sheets one by one to the image former 330.

### <Configuration of Reference Image Generator 380>

The reference image generator 380 generates a reference image based on a document image acquired by the document image acquirer and outputs the reference image to the controller 310. The reference image generator 380 can be implemented by a CPU (not illustrated) executing the image inspection program. The CPU that executes the image inspection program is different from the image control CPU 311. Thus, the image forming system 300 is configured to perform the generation of the reference image and the formation and inspection of the inspection image in parallel.

Conventionally, the same CPU has been configured to generate a reference image and form and inspect an inspection image. Therefore, since the CPU forms and inspect an inspection image after the completion of the generation of a reference image for each copy, the generation of the reference image and the formation and inspection of the inspection image cannot be performed in parallel. In the present embodiment, a CPU that is configured to generate a reference image may be separated from a CPU that forms and inspects an inspection image. With this configuration, the image forming system 300 can generate a reference image and form and inspect an inspection image in parallel.

Furthermore, the processing load (processing time) on the CPU for generating the reference image may increase or decrease depending on the complexity of the document image, whether or not variable printing is performed, and the like. For example, when the document image is a complicated image, the processing load on the CPU for generating the reference image may significantly increase. Since the CPU (hardware processor) other than the image control CPU 311 performs the generation of the reference image, the processing load on the image control CPU 311 can be reduced.

### <Configuration of Storage Device 390>

The storage device 390 stores the reference image generated by the reference image generator 380. When the document image is reprinted, the controller 310 does not need to generate the reference image again since the reference image stored in the storage device 390 is used. Therefore, the time required for generating the reference image can be saved.

### <Outline of Control Operation of Controller 310 and Print Controller 320>

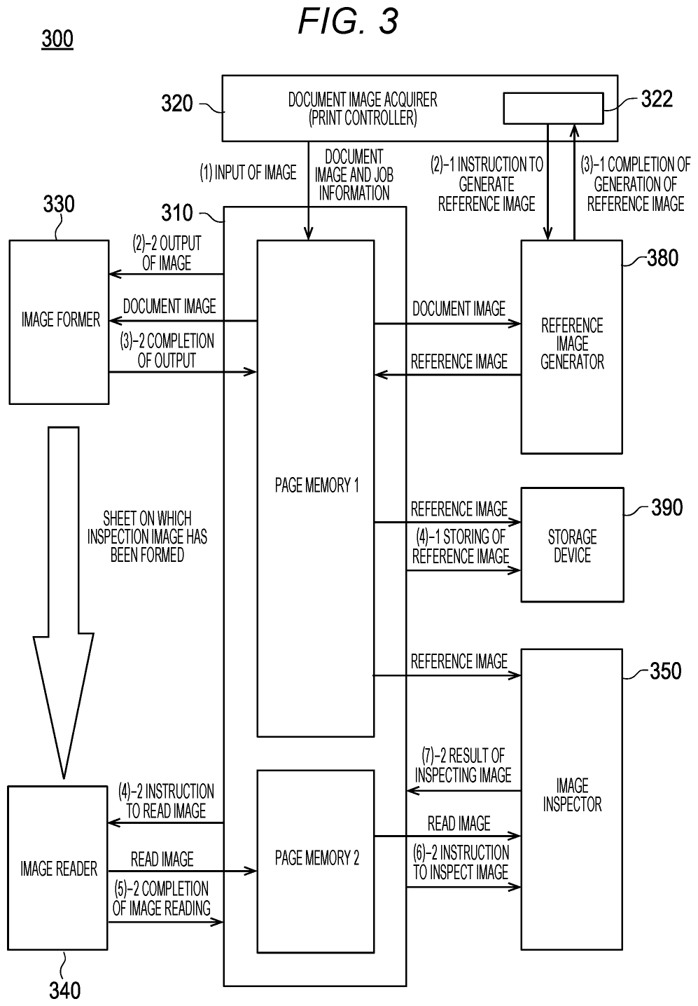

FIG. 3 is a block diagram for explaining the outline of a control operation of the controller 310 and the print controller 320 illustrated in FIG. 2.

First, the controller 310 receives a document image and job information from the document image acquirer (print controller 320) ((1) input of image). The document image is a RIP image obtained by rasterizing print data.

Upon receiving a reference image generation instruction from the reference image generation controller 322 ((2)-1 reference image generation instruction), the reference image generator 380 generates a reference image based on the document image acquired by the document image acquirer and outputs the reference image to the controller 310. The controller 310 stores the reference image in a page memory 1.

As described above, the reference image generator 380 generates the reference image by performing the various kinds of processing on the document image in terms of position, resolution, color, and the like. For example, the reference image generator 380 can extract position information of a content portion from the document image and add or embed the position information to or in the reference image so that the content portions (contents) of the reference image and the read image can be compared with each other. That is, the reference image generated by the reference image generator 380 includes alignment information for aligning the reference image with the read image when the image inspection is performed based on the reference image. The alignment information includes contour information and edge information of the image. In addition, the reference image generated by the reference image generator 380 has region information regarding an inspection region and an inspection exclusion region used when the image inspection is performed based on the reference image. Furthermore, the reference image generator 380 can generate a reference image by adjusting the resolution of the document image so as to match the resolution of the scanner of the image reader 340. Furthermore, the reference image generator 380 can generate a reference image by converting the color space of the document image so as to match the color space (e.g., RGB) used by the scanner of the image reader 340.

In addition, upon receiving the document image from the document image acquirer, the controller 310 instructs the image former 330 to form an image and outputs the document image stored in the page memory 1 to the image former 330 ((2)-2 output of output). In the present embodiment, the image former 330 forms an inspection image on a sheet based on the document image. The generation of the reference image by the reference image generator 380 and the formation of the inspection image by the image former 330 are performed in parallel.

When the generation of the reference image is completed, the reference image generator 380 notifies the reference image generation controller 322 of the completion of the generation of the reference image ((3)-1 completion of generation of reference image). Furthermore, when the image formation on the sheet is completed, the image former 330 notifies the controller 310 of the completion of the output ((3)-2 completion of output). The storage device 390 stores the generated reference image ((4)-1 storing of reference image).

Further, the controller 310 outputs an image reading instruction to the image reader 340 immediately after receiving the notification indicating the completion of the output ((4)-2 image reading instruction). The image reader 340 reads the sheet on which the inspection image has been formed, and outputs the read image of the sheet to the controller 310. The controller 310 stores the read image in the page memory 2. When the reading of the sheet is completed, the image reader 340 provides a notification indicating the completion of the image reading ((5)-2 completion of image reading).

The controller 310 receives the notification indicating the completion of the image reading and outputs an image inspection instruction to the image inspector 350 ((6)-2 image inspection instruction). The image inspector 350 acquires the reference image and the read image from the page memory 1 and the page memory 2, respectively, and inspects the inspection image by comparing the reference image with the read image. Then, the image inspector 350 outputs the result of inspecting the inspection image to the controller 310 ((7)-2 result of inspecting image).

In response to an instruction from the user, the controller 310 performs control such that the result (indicating a non-defective product or a defective product) of inspecting the printed product is displayed on the operation and display part 360 or the display of the client terminal 200, based on the result of inspecting the inspection image.

### <Image Inspection Method>

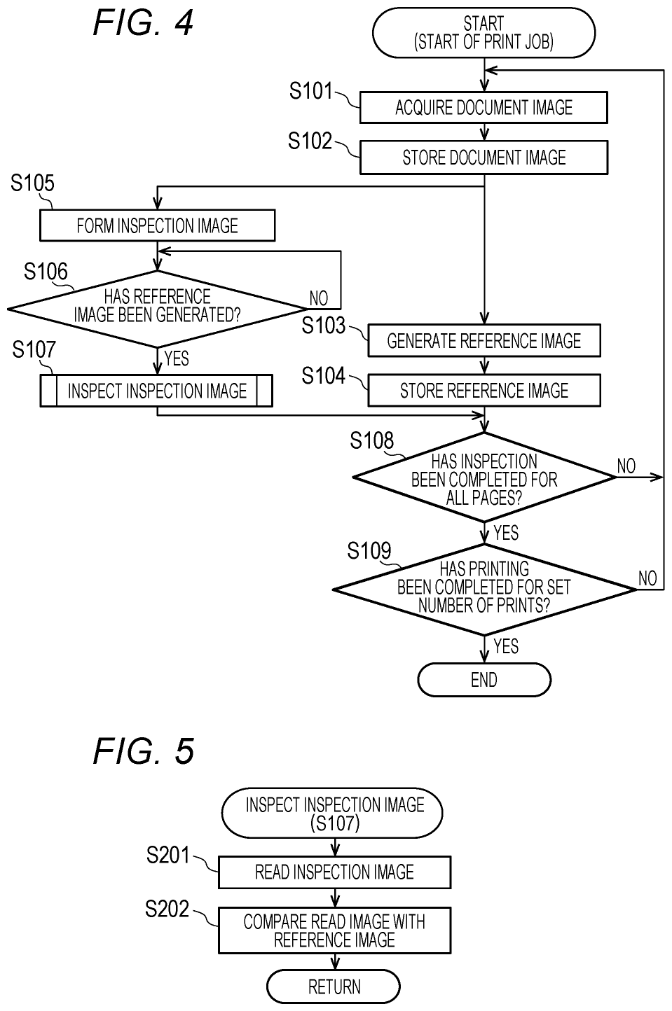

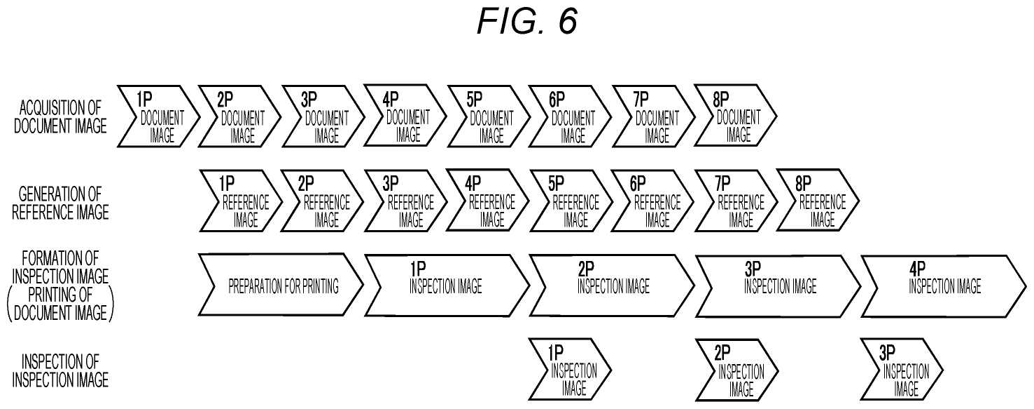

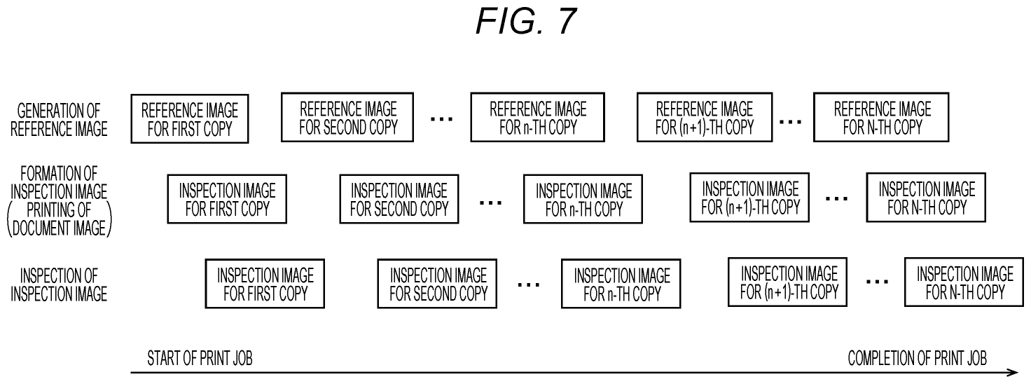

FIG. 4 is a flowchart illustrating a processing procedure of an image inspection method by the image forming system 300 illustrated in FIG. 1. FIG. 5 is a subroutine flowchart illustrating details of the inspection of an inspection image in the flowchart illustrated in FIG. 4. The processes illustrated in FIGS. 4 and 5 are implemented by the image control CPU 311 executing the image inspection program. FIG. 6 is a schematic diagram illustrating, in a time-series manner, processing of acquisition of a document image, generation of a reference image, formation of an inspection image, and inspection of the inspection image. FIG. 7 is a schematic view illustrating printing of a plurality of copies of a document image in time series.

As illustrated in FIG. 4, first, the controller 310 acquires a document image (step S101). The document image includes one copy or a plurality of copies, and each copy can include one page or a plurality of pages. In a case where the document image includes a plurality of copies, for example, the controller 310 receives the document image in order from the first copy to the last N-th copy. For each copy, the controller 310 sequentially receives, from the document image acquirer, the first page to the last m-th page of the document image (RIP image) page by page in order from the first page to the last m-th page. For example, FIG. 6 illustrates a case where the document image includes a plurality of copies and the first to eighth pages of the n-th copy are sequentially received. In FIG. 7, “IP” represents the first page (the same applies to “2P” and the like). In addition, “preparation for printing” in the formation of an inspection image includes initial settings and preparation (for example, warm-up of a fixer) of each part according to an image forming condition in the image former 330.

Next, the controller 310 stores the document image (step S102). When a print job is started, the controller 310 stores the document image acquired from the document image acquirer in the page memory 1 on a page-by-page basis.

Next, the reference image generation controller 322 controls generation of a reference image to be used for inspection of the inspection image. The reference image generator 380 generates a reference image in accordance with an instruction from the reference image generation controller 322 (step S103). For example, when the first page of the document image is acquired and stored in the page memory 1, the reference image generation controller 322 controls the reference image generator 380 to generate the reference image based on the first page of the document image. The reference image generator 380 generates a reference image based on the first page of the document image. A reference image is similarly generated for the second page of the document image.

Next, the storage device 390 stores the reference image generated by the reference image generator 380 (step S104). For example, the storage device 390 stores the first page and the second page of the document image. Furthermore, as illustrated in FIG. 6, in parallel with the processing in steps S103 and S104, the controller 310 controls the image former 330 to form an inspection image on a sheet based on the document image and the job information received from the document image acquirer. For example, the controller 310 performs preparation for printing and controls the image former 330 to form an inspection image on a sheet for the document image of the first page. The image former 330 forms an inspection image of the first page of the document image on a sheet in accordance with an instruction from the controller 310 (step S105). After the inspection image for the document image of the first page is formed, an inspection image for the document image of the second page is similarly formed on the sheet.

Next, the image inspector 350 determines whether or not a reference image has been generated for each page of the acquired document image (step S106). In a case where the reference image has been generated (step S106: YES), the image inspector 350 inspects the inspection image formed by the image former 330 (step S107). On the other hand, in a case where the reference image has not been generated (step S106: NO), the image inspector 350 waits until the reference image is generated. For example, in a case where the reference image for the same document image (first page) as the document image (first page) serving as the source of the inspection image to be inspected in step S107 has not been generated, the image inspector 350 waits until the reference image for the document image (first page) is generated.

As illustrated in FIG. 6, the generation of the reference image by the reference image generator 380 and the formation and inspection of the inspection image by the image former 330 are performed in parallel. Thus, the image forming system 300 can further shorten the time required for the processing from the generation of the reference image to the image inspection as compared with the conventional technology.

### [Generation of Reference Image and Formation of Inspection Image on Sheet in Parallel]

For example, in the example illustrated in FIG. 6, the generation of the reference images for the first page (1P) and the second page (2P) and the preparation for printing are performed in parallel, and the generation of the reference image for the third page (3P) and the formation (first half) of the inspection image for the first page (IP) are performed in parallel. After that, the generation of the reference image for the fourth page (4P) and the formation of the inspection image for the first page (IP) (second half) are simultaneously performed. Note that although the generation of the reference image for the third page (3P) and the formation of the inspection image for the first page (1P) are illustrated as being started at the same time in FIG. 6, they are not limited thereto. The formation of the inspection image for the first page (IP) can be started at an appropriate timing after the completion of the preparation for printing, and the generation of the reference image for the third page (3P) can be started at an appropriate timing after the generation of the reference image for the second page (2P). The generation of a reference image and the generation of an inspection image for each of the subsequent pages are started in a similar manner to those described above.

### [Generation of Reference Image, Formation of Inspection Image on Sheet, and Inspection of Inspection Image in Parallel]

Thereafter, the generation of the reference image for the fifth page (5P), the formation of the inspection image for the second page (2P), and the inspection of the inspection image for the first page are simultaneously performed.

As illustrated in FIG. 5, in the processing of inspecting the inspection image, the image reader 340 reads the inspection image formed on the sheet (step S201), and the image inspector 350 compares the reference image with the read image to inspect the inspection image (step S202).

The controller 310 repeats the processing in steps S101 to S107 until the inspection of the inspection images is completed for all the pages (from the first page to the last m-th page) (step S108).

Further, the controller 310 repeats printing up to the number of prints set in the job information (step S109). As illustrated in FIG. 7, in the present embodiment, for example, in a case where the set number of prints is N, the reference image generator 380 generates a reference image N times until printing is completed. That is, the reference image generator 380 performs processing for generating a reference image for each page for each of the copies. Thus, the reference image generator 380 generates, for each of the copies, a reference image to be used for inspection of the inspection image formed on each of sheets of the plurality of copies by the image former 330.

As described above, in the present embodiment, the controller 310 can perform control such that the generation of a reference image and the formation of an inspection image are performed in parallel. When the number of prints is two or more, the controller 310 can perform control such that generation of a reference image and formation of an image on a sheet are performed in parallel for each of copies. For example, the controller 310 performs control such that generation of a reference image and formation of an inspection image are performed in parallel for the first copy among the plurality of copies.

Further, processing of generating a reference image is referred to as reference image generation processing, and processing including formation of an inspection image on a sheet and inspection of a read image generated by reading the sheet on which the inspection image has been formed is referred to as inspection processing. The controller 310 can perform control such that the reference image generation processing and the inspection processing are performed in parallel for the n-th copy among the plurality of copies. For example, the controller 310 performs control such that the reference image generation processing and the inspection processing are performed in parallel for the first copy among the plurality of copies.

Furthermore, the controller 310 can perform control such that the generation of the reference image for the (n+1)-th copy among the plurality of copies is performed in parallel with the inspection of a sheet of the n-th copy among the plurality of copies. For example, the controller 310 performs control such that the generation of the reference image for the second copy among the plurality of copies is performed in parallel with the inspection of a sheet of the first copy among the plurality of copies.

As described above, in the present embodiment, while a reference image is generated based on the reception of a document image (with the reception of the document image as a starting point), an inspection image is formed on a sheet and the inspection of the inspection image is performed when the preparation for printing is completed. In the present embodiment, since the generation of the reference image and the formation and inspection of the inspection image are performed in parallel, the time taken for the processing from the generation of the reference image to the image inspection can be shortened. As a result, the productivity in a series of processes until a printed product without abnormality is produced is improved. Furthermore, the processing for generating a reference image for each page is performed for a plurality of copies, so that the reference image is generated for each of the copies.

### <Release of Page Memory 1>

In the inspection of an inspection image, a reference image for which the comparison with a read image has been completed becomes unnecessary. For example, at the timing when a result of inspecting the inspection image is accepted, the controller 310 can release (overwrite) the storage area of the page memory 1 in which the reference image for which the comparison with the read image has been completed is stored. A new reference image can be stored in the released storage area. Thus, even in a case where it is assumed that a document image has a large number of pages, consumption of a large amount of the storage area of the page memory 1 is suppressed.

### <Print Job>

As described above, when the image forming system 300 receives the print job, and the inspection setting of the job information is inspection-on, the image forming system 300 performs the generation of the reference image and the formation of the inspection image are executed in parallel. The controller 310 and the print controller 320 perform control such that the generation of the reference image by the reference image generator 380 and the formation of the inspection image by the image former 330 are performed in parallel for one (same) print job.

On the other hand, the image forming system 300 may implement the generation of the reference image and the formation and inspection of the inspection image for separate print jobs. The controller 310 and the print controller 320 perform control so as to perform the reference image generation processing (reference image generation job) and the inspection processing (inspection job) in parallel. Here, the reference image generating processing includes generation of a reference image by the reference image generator 380. The inspection processing includes formation of an inspection image on a sheet by the image former 330 and image inspection, by the image inspector 350, of a read image generated by reading the sheet on which the inspection image has been formed. For example, the reference image generation processing can be performed by the CPU different from the image control CPU 311, and the inspection processing can be performed by the image control CPU 311.

### <Recovery Printing>

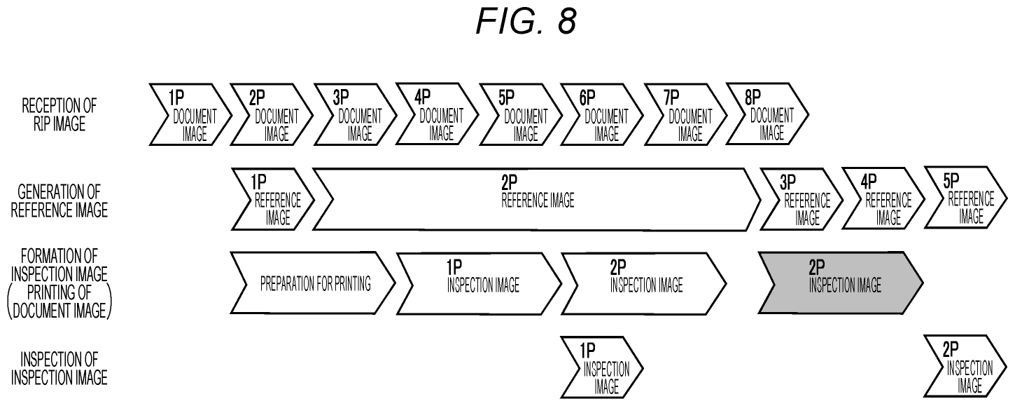

In addition, FIG. 8 is a schematic diagram illustrating, in a time-series manner, processing of acquisition of a document image, generation of a reference image, formation of an inspection image, and inspection of the inspection image when recovery printing is performed.

The controller 310 and the image former 330 function as a recovery printing section. When an abnormality is detected in an inspection image, the recovery printing section performs reprinting (recovery printing) from a page of the document image corresponding to a page that is included in the inspection image and in which the abnormality has been detected. In the present embodiment, when the inspection image is defective as a result of inspection of the inspection image by the image inspector 350, the controller 310 determines that an abnormality has been detected in the inspection image. The controller 310 purges, to the outside of the image forming system 300, the sheet on which the inspection image in which the abnormality has been detected has been formed as waste sheet.

Furthermore, in general, the more complicated a document image is, the more time is required for the reference image generator 380 to generate a reference image. For example, FIG. 7 illustrates an example in which the second page of the document image is complicated, and thus it takes time to generate the second page of the reference image. The recovery printing section performs recovery printing when the generation of the reference image is not completed by the time of the inspection of the corresponding inspection image. For example, in the example illustrated in FIG. 7, since the generation of the second page of the reference image is not completed even after the formation of the second page of the inspection image, the recovery printing section waits for the completion of the generation of the reference image and then performs the recovery printing of the second page of the document image (formation of the second page of the inspection image). The controller 310 purges the sheet of the second page of the already printed inspection image. Thus, a sheet on which an uninspected inspection image has been formed is prevented from being mixed with a sheet on which a normal inspection image has been formed.

Furthermore, the image inspector 350 can perform image inspection using the reference image stored in the storage device 390 during recovery printing. Thus, since it is not necessary to generate the reference image again by the reference image generator 380, the time required for generating the reference image can be saved.

Furthermore, the image forming system 300 can be configured to store the document image stored in the page memory 1 in step S102 illustrated in FIG. 4 in the storage device 390 when performing the recovery printing. Using the document image stored in the storage device 390 eliminates the need for the processing in steps S103 and S104 in addition to the processing of generating and storing the reference image (steps S101 and S102). Therefore, the controller 310 and the print controller 320 control to perform only the processing of the formation and inspection of the inspection image in the print job. Thus, the time required from the start of the print job to the completion of the inspection of a printed product can be shortened. As a result, the productivity of a printed product is improved.

The image inspection apparatus, the image inspection method, and the image inspection program according to the present embodiment described above can obtain the following effects.

A reference image to be used for inspection of an image formed on each of sheets of a plurality of copies is generated for each of the copies. Therefore, a storage area in a page memory that stores a reference image for which the inspection of an inspection image has been completed can be released. As a result, even when the number of pages of a document image is large, it is possible to suppress a large amount of storage area of the page memory from being consumed.

As described above, the image inspection apparatus, the image inspection method, and the image inspection program have been described in the embodiment. However, it is needless to say that those skilled in the art can appropriately make addition, modifications, and omissions with respect to the present invention within the scope of the technical idea thereof.

The computer-readable image inspection program may be provided by a non-transitory recording medium such as a USB memory, a flexible disk, or a CD-ROM, or may be provided online via a network such as the Internet. In this case, the computer-readable program recorded on the non-transitory recording medium is usually transferred to and stored in a memory, a storage, or the like. Furthermore, this image inspection program may be provided, for example, as independent application software, or may be incorporated, as one function of the server, into software of each device.

Furthermore, a part or a whole of the processes performed by the inspection program in the embodiment can be performed in the form of hardware such as a circuit.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection apparatus comprising a hardware processor, wherein the hardware processor generates, for each of copies, a reference image to be used for inspection of an image formed on each of recording media of the plurality of copies, and inspects the image formed on each of the recording media of the plurality of copies based on acquired image data.

2. The image inspection apparatus according to claim 1, wherein the reference image is generated based on the acquired image data.

3. The image inspection apparatus according to claim 1, wherein the hardware processor performs control such that the generation of the reference image and the formation of the image on the recording media are performed in parallel for a first copy among the plurality of copies.

4. The image inspection apparatus according to claim 1, wherein the hardware processor performs control such that the generation processing of the reference image and inspection processing including the formation of the image on the recording media and the inspection of a read image generated by reading the recording media on which the image has been formed are performed in parallel for a first copy among the plurality of copies.

5. The image inspection apparatus according to claim 1, wherein the hardware processor performs control such that generation of a reference image of a second copy among the plurality of copies is performed in parallel with inspection of a recording medium of a first copy among the plurality of copies.

6. The image inspection apparatus according to claim 1, wherein the hardware processor performs control such that generation of a reference image for an (n+1)-th copy among the plurality of copies is performed in parallel with inspection of a recording medium of an n-th copy among the plurality of copies.

7. An image inspection method for an image inspection apparatus including a hardware processor that inspects an image formed on each of recording media of a plurality of copies based on acquired image data, the image inspection method comprising causing the hardware processor to generate, for each of the copies, a reference image to be used for inspection of the image formed on each of the recording media of the plurality of copies.

8. A non-transitory recording medium storing a computer-readable image inspection program for an image inspection apparatus including a hardware processor that inspects an image formed on each of recording media of a plurality of copies based on acquired image data, the computer-readable image inspection program comprising a procedure of generating, for each of the copies, a reference image to be used for inspection of the image formed on each of the recording media of the plurality of copies.

9. An image forming system comprising:
an image former that forms an image on a recording medium based on acquired image data; and
the image inspection apparatus according to claim 1.

10. An image forming system comprising:
an image former that forms an image on a recording medium based on acquired image data; and
the image inspection apparatus according to claim 2.
